(19) United States
(12) Patent Application Publication
(10) Pub. No.: US 2002/0068688 A1
(43) Pub. Date: Jun. 6, 2002

(54) Cleaning compositions

(75) Inventors: Ian Charles Callaghan, Vlaardingen (NL); Roger Anna Janssen, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/981,939

(22) Filed: Oct. 17, 2001

(30) Foreign Application Priority Data
Oct. 18, 2000 (EP) 00203631.7

(51) Int. Cl. C11D 17/00

(52) U.S. Cl. 510/446; 510/447

(57) ABSTRACT

A tablet of compacted particulate cleaning composition comprising:

(a) a cleaning ingredient selected from the group consisting of organic surfactant, water softening agent, bleach and mixtures thereof, and

(b) from about 0.1 to about 10 wt % of the tablet of a disintegration-promoting material which is an alkyl polyglycoside, and wherein from about 0.1 to about 3 wt % of the tablet is the alkyl polyglycoside present as the coating for from about 30 wt % to about 100 wt % of the particulate cleaning composition.

This invention relates to cleaning compositions in the form of tablets. These tablets are intended to disintegrate when placed in water and thus are intended to be consumed in a single use. The tablets may be suitable for use in machine dishwashing, the washing of fabrics or other cleaning tasks.

Detergent compositions in tablet form and intended for fabric washing have been described in a number of patent documents including, for example EP-A-711827, WO-98/42817 and WO-99/20730 (Unilever) and are now sold commercially. Tablets containing bleach for use as an additive to a fabric washing liquor have been disclosed in U.S. Pat. No. 4,013,581 (Procter and Gamble). Tablets containing a water softening agent, for use as an additive in cleaning, are sold commercially and are one form of tablet disclosed in EP-A-838519 (Unilever). Tablets of composition suitable for machine dishwashing have been disclosed in EP-A-318204 and U.S. Pat. No. 5,691,293 and are sold commercially.

Tablets have several advantages over powdered products: they do not require measuring and are thus easier to handle and dispense into the washload, and they are more compact, hence facilitating more economical storage.

Tablets of a cleaning composition are generally made by compressing or compacting a composition in particulate form. Although it is desirable that tablets have adequate strength when dry, yet disperse and dissolve quickly when brought into contact with water, it can be difficult to obtain both properties together. Tablets formed using a low compaction pressure tend to crumble and disintegrate on handling and packing; while more forcefully compacted tablets may be sufficiently cohesive but then fail to disintegrate or disperse to an adequate extent in the wash. Tableting will often be carried out with enough pressure to achieve a compromise between these desirable but antagonistic properties. However, it remains desirable to improve one or other of these properties without detriment to the other so as to improve the overall compromise between them.

If a tablet contains organic surfactant, this functions as a binder, plasticising the tablet. However, it can also retard disintegration of the tablet by forming a viscous gel when the tablet comes into contact with water. Thus, the presence of surfactant can make it more difficult to achieve both good strength and speed of disintegration: the problem has proved especially acute with tablets formed by compressing powders containing surfactant and built with insoluble detergency builder such as sodium aluminosilicate (zeolite).

In our patent applications WO 98/46719 and WO 98/46720 we have taught that the speed of disintegration of tablets can be improved by stamping with dies (also known as punches) which bear a surface of an elastomeric material. This leads to an improved porosity at the tablet surface.

It is known to include materials whose function is to enhance disintegration of tablets when placed in wash water. For example, our EP-A-838519 mentioned above teaches the use of sodium acetate trihydrate for this purpose.

A number of documents have taught that the disintegration of tablets of cleaning composition can be accelerated by incorporating in the tablet a quantity of a water-insoluble but water-swellable material serving to promote disintegration of the tablet when placed in water at the time of use. Such documents include EP-A-466484, EP-A-482627 and WO-98/40463.

We have found that the speed of disintegration of a tablet can be increased by using alkyl polyglycosides as a coating material for (at least part of) the particulate cleaning composition constituting the tablet.

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

So, according to a first aspect of this invention, there is provided a tablet of compacted particulate cleaning composition comprising at least one cleaning ingredient which is an organic surfactant, a water softening agent or a bleach, wherein an alkyl polyglycoside is present as disintegration-promoting material and wherein at least part of the alkyl polyglycoside is present as a coating material for at least part of the particulate cleaning composition.

The tablet may comprise a mixture of organic surfactant, water softening agent and/or bleach cleaning ingredients.

According to a particularly preferred form of the first aspect, the alkyl polyglycoside is of the formula:

R—O—(C₆H₁₀O₅)ₙ—H (I)

Wherein R is a C₄ to C₂₄ alkyl group, more preferred a C₈ to C₁₆ alkyl group; and wherein n denotes the average number of sugar groups per molecule and wherein n=from 0.1 to 5, more preferred from 0.5 to 2.0, most preferred from 1.0 to 1.5, or mixtures thereof.

Preferably the overall quantity of alkyl polyglycoside material in the tablet is between 0.1 and 10.0% by weight of the tablet, more preferred from 0.5 to 5 wt %, most preferred from 1.0 to 3.0 wt %.

This invention is particularly applicable when the tablets contain both surfactant and detergency builder, as in tablets for fabric washing.

In a second aspect this invention provides a process for making a tablet which comprises placing a quantity of particulate cleaning composition within a mould and compacting that composition within the mould, characterised in that, prior to placing said cleaning composition in the mould, an alkyl polyglycoside is applied as a coating to at least part of the particulate cleaning composition.

Forms of this invention, preferred and optional features, and materials which may be used, will now be discussed in greater detail.

Alkyl polyglycoside

Alkyl polyglycosides are well-known components for use in detergent compositions.

DE 197 54 289 (Henkel KGaA) and EP 863 200 (Henkel) disclose the use of alkyl polyglycosides in tablet compositions. The alkyl polyglycoside is incorporated in the tablet as part of the particulate cleaning composition.

DE 198 24 742 (Henkel KgaA) discloses the preparation of detergent granules whereby alkyl polyglycosides are applied as granulating agents.

DE 199 03 288 (Henkel KGaA) and EP 1 043 391 (Stockhausen GmbH et al) disclose detergent tablet compositions comprising cellulose disintegrants and optionally alkyl glycoside surfactants.

It has now been found that alkyl polyglycosides improve the disintegration properties of a detergent composition in tablet form, provided the alkyl polyglycoside is present as a coating material. In particular the alkyl polyglycoside material can be applied as a coating to part or all of the particulate cleaning composition prior to compacting said cleaning composition into a tablet. Preferably the alkyl polyglycoside is applied as coating to a significant part of the particulate cleaning composition, for example to more than 30 wt % of the cleaning composition. The alkyl polyglycoside are preferably applied to a base powder particulate composition comprising the surfactant materials as stated above as this provides more convenient manufacture. Preferably the alkyl polyglycoside is applied to 30 or 35 to 60, 70 or 90 wt % of the particulate cleaning composition. The alkyl polyglycoside can be applied to a base powder composition or to a substantial part of the entire cleaning composition constituting the tablet e.g. to more than 75 wt % of the cleaning composition, especially preferred to from 90 to 100 wt %.

For tablet compositions which contain a surfactant, it is especially preferred that the alkyl polyglycoside is applied as a coating to a granulated mixture comprising at least one other surfactant but which has a very small amount, if any, of ingredients added post-granulation. It is preferably applied as a coating to the tablet composition base powder particles. Further alkyl polyglycoside may be applied as a coating to the final product which is formed by adding post-dosed ingredients to the granulated base powder. Alternatively the alkyl polyglycoside may be applied as a coating only to the final product.

For the purpose of the invention the term coating refers to the application of alkyl polyglycosides to the outer surface of the composition to be coated. It is not essential that the application of the alkyl polyglycosides to the outer surface of the composition results in total coverage thereof. For example, a discontinuous coating may be acceptable when a significant proportion of the total area is covered. Generally, the greater the percentage of surface area covered the better the disintegration properties.

The application of the alkyl polyglycoside to the particulate cleaning composition can be done by any suitable method. Especially suitable is the spraying of a solution or paste of alkyl polyglycoside onto the particulates. Suitably such a solution may comprise alkyl polyglycosides in a solvent and products of an approximately 50 wt % aqueous solution are available, for example from Cognis, Germany. A preferred solvent for this purpose is water. Preferred concentrations of the alkyl polyglycoside in the solvent are from 5 to 90 wt %, more preferred 20 to 80 wt %, most preferred from 30 to 70 wt %.

The alkyl polyglycosides may be mixed with other materials to form the coating composition. This typically reduces the level of water in the coating composition which may aid the coating application process and/or the further preparation of the tablets. Materials which have a function in the tablet are especially preferred for incorporation in the coating composition. Suitable materials include surfactants and other materials which have a melting point below the temperature at which the coating composition is applied to the particulate composition. Thus in the coating composition when it is applied to the particulate composition these materials have a substantial liquid character. The coating composition is typically applied to the particulate composition at a temperature in the region of 55 to 85° C. Suitable materials include nonionic surfactants such as the C_{9 11} and C_{10 15} primary and secondary alcohols ethoxylated with an average of from 3 to 10 moles of ethylene oxide per mole of alcohol and methyl ester ethoxylates.

The alkyl polyglycoside is applied to the particulate cleaning composition prior to compacting this into a tablet.

The alkyl polyglycoside material is incorporated as a coating composition into the tablet in an amount sufficient to act as a disintegration-promoting material. The level of alkyl polyglycoside material in the tablet is preferably between 0.1 and 10.0% by weight of the tablet more preferred from 0.5 to 5 wt %, most preferred from 1.0 to 3.0 wt %. It will be appreciated that for the purpose of the invention the alkyl polyglycoside will mainly be used as a coating material, however, it is also possible that part of the alkyl glycoside is incorporated in the particulate cleaning composition. Preferably, however the level of alkyl polyglycoside that is used as coating material is at least 0.1 wt %, more preferred at least 0.5 wt %, most preferred at least 1 wt % based on the total weight of the tablet. The level of alkyl polyglycoside that is used as coating material preferably lies in the range 0.1 to 3 wt %, more preferably 0.5 to 2.5 wt %, most preferably 0.8 to 2.5 wt %, such as 1 or 1.5 to 2 wt % based on the total weight of the tablet. This especially applies when the alkyl polyglycoside is applied as a coating to the overall formulation. If the alkyl polyglycoside is added as a coating to a base powder composition only then the alkyl polyglycoside is preferably used in an amount of 1 to 4 or 5 wt % based on the total weight of the base powder and alkyl polyglycoside coating, preferably 2 to 4 wt %, more preferably 3 to 4 wt %. The amount of alkyl polyglycoside referred to herein is the amount of the material per se and not the coating composition which also may include solvents and other suitable material.

It has been found that the addition of too great a quantity of alkyl polyglycoside as a coating composition can adversely affect the physical properties of the particulate composition being coated. One manifestation of this which has been found is that the addition of too great a quantity of alkyl polyglycoside has been found to produce a particulate composition which is very coarse in particle size.

For the purpose of the invention a wide range of alkyl polyglycosides may be used.

Alkyl polyglycosides satisfy the general formula RO(G)ₓ wherein R is a linear or branched, saturated or unsaturated aliphatic group. Preferably R is an linear or branched alkyl or alkylaryl group having from 4 to 24 carbon atoms. For the purpose of the invention a preferred branched alkyl group comprises a C₁₋₄ alkyl side group at the two position, whereby preferred side groups are methyl or ethyl side groups.

G can be any glycoside group for example glucose, xylose, fructose or maltose. For the purpose of this invention, preferably G is a glucose, so that alkyl polyglucosides are especially preferred.

X denotes the average number of glycoside groups and may for example be from 0.1 to 5, more preferred from 0.5 to 2, most preferred from 1.0 to 1.5.

Especially preferably the alkyl polyglycosides are of the following formula

R—O—(C₆H₁₀O₅)ₙ—H (I)

Wherein R is a C₄ to C₂₄ alkyl group; and wherein n denotes the average number of sugar groups per molecule and wherein n=from 0.1 to 5, or mixtures thereof.

Most preferably the alkyl polyglycoside is of the formula (I) wherein R is a C₈ to C₁₆ alkyl group; and wherein n=from 0.5 to 2.0, or mixtures thereof.

Suppliers of alkyl polyglycosides (APGs) include Cognis, Rohm & Haas, Akzo and BASF and other companies listed in the McCutcheons's Guide to Detergents and Emulsifiers. Examples of suitable alkyl polyglycosides are provided in the examples.

Surfactant Compounds

Compositions which are compacted to form tablets or tablet regions of this invention may contain one or more organic detergent surfactants. In a fabric washing composition, these preferably provide from 5 to 50% by weight of the overall tablet composition, more preferably from 8 or 9% by weight of the overall composition up to 40%, 49% or 50% by weight. Surfactant may be anionic (soap or non-soap), cationic, zwitterionic, amphoteric, nonionic or a combination of these.

Anionic surfactant may be present in an amount from 0.5 to 50% by weight, preferably from 2% or 4% up to 30% or 40% by weight of the tablet composition.

In a machine dishwashing composition, organic surfactant is likely to constitute from 0.5 to 8%, more likely from 0.5 to 4.5% of the overall composition and is likely to consist of nonionic surfactant, either alone or in a mixture with anionic surfactant.

Synthetic (i.e. non-soap) anionic surfactants are well known to those skilled in the art. Examples include alkylbenzene sulphonates, particularly sodium linear alkylbenzene sulphonates having an alkyl chain length of C₈-C₁₅; olefin sulphonates; alkaline sulphonates; dialkyl sulphosuccinates; and fatty acid ester sulphonates.

Primary alkyl sulphate having the formula;

ROSO₃⁻M⁺

in which R is an alkyl or alkenyl chain of 8 to 18 carbon atoms especially 10 to 14 carbon atoms and M⁺ is a solubilising cation, is commercially significant as an anionic surfactant.

Linear alkyl benzene sulphonate of the formula;

R—Ar—SO₃⁻M⁺

where R is linear alkyl of 8 to 15 carbon atoms, Ar is an aryl group and M⁺ is a solubilising cation, especially sodium, is also a commercially significant anionic surfactant.

Frequently, such linear alkyl benzene sulphonate or primary alkyl sulphate of the formula above, or a mixture thereof will be the desired anionic surfactant and may provide 75 to 100 wt % of any anionic non-soap surfactant in the composition.

In some forms of this invention the amount of non-soap anionic surfactant lies in a range from 5 to 20 or 25 wt % of the tablet composition.

It may also be desirable to include one or more soaps of fatty acids. These are preferably sodium soaps derived from naturally occurring fatty acids, for example, the fatty acids from coconut oil, beef tallow, sunflower or hardened rapeseed oil.

Suitable nonionic surfactant compounds which may be used include in particular the reaction products of compounds having a hydrophobic group and a reactive hydrogen atom, for example, aliphatic alcohols, acids, amides or alkyl phenols with alkylene oxides, especially ethylene oxide.

Specific nonionic surfactant compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine.

Especially preferred are the primary and secondary alcohol ethoxylates, especially the C₉₋₁₁ and C₁₂₋₁₅ primary and secondary alcohols ethoxylated with an average of from 3 to 20 moles of ethylene oxide per mole of alcohol.

In certain forms of this invention the amount of nonionic surfactant lies in a range from 4 to 40%, better 4 or 5 to 30% by weight of the composition. Many nonionic surfactants are liquids. These may be absorbed onto particles of the composition, prior to compaction into tablets.

Amphoteric surfactants which may be used jointly with anionic or nonionic surfactants or both include amphopropionates.

The category of amphoteric surfactants also includes amine oxides and also zwitterionic surfactants, for example betaines. Another example of amphoteric surfactant is amine oxide.

The amount of amphoteric surfactant, if any, may possibly be from 3% to 20 or 30% by weight of the tablet or region of a tablet; the amount of cationic surfactant, if any, may possibly be from 1% to 10 or 20% by weight of the tablet or region of a tablet.

Water-softening Agent

A composition which is compacted to form tablets or tablet regions may contain a so-called water-softening agent which serves to remove or sequester calcium and/or magnesium ions in the water. In the context of a detergent composition containing organic surfactant, a water-softening agent is more usually referred to as a detergency builder.

When a water-softening agent (detergency builder) is present, the amount of it is likely to lie in a broad range from 5%, preferably 15 wt % up to 98% of the tablet composition. In detergent tablets the amount is likely to be from 15 to 80%, more usually 15 to 60% by weight of the tablet.

Water-softening agents may be provided wholly by water soluble materials, or may be provided in large part or even entirely by water-insoluble material with water-softening properties.

Alkali metal aluminosilicates are strongly favoured as environmentally acceptable water-insoluble softening agents (detergency builders) for fabric washing. Alkali metal (preferably sodium) aluminosilicates may be either crystalline or amorphous or mixtures thereof, having the general formula:

0.8−1.5Na₂O.Al₂O₃.0.8−6SiO₂.XH₂O

These materials contain some bound water (indicated as xH₂O) and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature.

Suitable crystalline sodium aluminosilicate ion-exchange materials are described, for example, in GB 1429143 (Procter & Gamble). The preferred sodium aluminosilicates of this type are the well known commercially available zeolites A and X, the newer zeolite P described and claimed in EP 384070 (Unilever) and mixtures thereof. This form of zeolite P is also referred to as “zeolite MAP”. One commercial form of it is denoted “zeolite A24”.

Conceivably a water-softener (detergency builder) could be a layered sodium silicate as described in U.S. Pat. No. 4,664,839. NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3,417,649 and DE-A-3,742,043. Other such layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0 can be used.

The category of water-soluble phosphorus-containing inorganic softeners includes the alkali-metal orthophosphates, metaphosphates, pyrophosphates and polyphosphates. Specific examples of inorganic phosphate detergency builders include sodium and potassium tripolyphosphates, orthophosphates and hexametaphosphates.

Non-phosphorus water-soluble water-softening agents may be organic or inorganic. Inorganics that may be present include alkali metal (generally sodium) carbonate; while organics include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates. Tablet compositions preferably include polycarboxylate polymers, more especially polyacrylates and acrylic/maleic copolymers which have some function as water-softening agents and also inhibit unwanted deposition onto fabric from the wash liquor.

The water-soluble builders may be present in the amount stated above, in particular in amounts of from 10-80% by weight. The water-insoluble builders may be present in the amount stated above, in particular in amounts of from 5-98% by weight.

Tablets according to one aspect of the present invention, preferably comprise from 5 to 50% by weight of surfactant and from 5 to 80% by weight of water-softening agent. These tablets are especially suitable for fabric washing applications.

Tablets according to a second aspect of the present invention preferably comprise from 0 to 5% by weight of surfactant, and either from 50 to 98% by weight of water-softening agent or from 25 to 85% by weight of a bleach. These tablets are especially suitable for machine dishwashing applications or for use as fabric washing auxiliary tablets.

Bleach System

Tabletted compositions according to the invention may contain a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 85% by weight of the composition. If the tablet contains surfactant and detergency builder, the amount of peroxygen compound bleach is unlikely to exceed 25% of the composition.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), now in widespread commercial use in conjunction with bleach materials. The quaternary ammonium and phosphonium bleach activators disclosed in U.S. Pat. Nos. 4,751,015 and 4,818,426 (Lever Brothers Company) are also of interest. Another type of bleach activator which may be used, but which is not a bleach precursor, is a transition metal catalyst as disclosed in EP-A-458397, EP-A-458398 and EP-A-549272. A bleach system may also include a bleach stabiliser (heavy metal sequestrant) such as ethylenediamine tetramethylene phosphonate and diethylenetriamine pentamethylene phosphonate.

Disintegration-Promoting Particles

A tablet or a region of a tablet may optionally also contain particles to promote disintegration. These would be in addition to the alkyl polyglycoside as described above. Water soluble and/or water swellable disintegration promoting materials may be incorporated into the compositions.

Such particles typically contain at least 40% (of their own weight) of one or more materials selected from

compounds with a water-solubility exceeding 50 grams per 100 grams water

water swellable materials such as for example cellulose, cross-linked carboxymethyl cellulose, cross-linked polyvinyl pyrrolidone or an acrylic/maleic copolymer

phase I sodium tripolyphosphate

sodium tripolyphosphate which is partially hydrated so as to contain water of hydration in an amount which is at least 0.5% by weight of the sodium tripolyphosphate in the particles.

A particular preferred class of water swellable materials are the water swellable celluloses, for example, Arbocel®-B and Arbocel®-BC (beech cellulose), Arbocel®-BE (beech-sulphite cellulose), Arbocel®-B-SCH (cotton cellulose), Arbocel®-FIC (pine cellulose) as well as further Arbocel® types from Rettenmaier and cellulose derivatives, for example Courlose™ and Nymcel™, sodium carboxymethyl cellulose, Ac-di-Sol™ cross-linked modified cellulose, and Hanfloc™ microcrystalline cellulosic fibres; and various synthetic organic polymers.

Cellulose-containing fibrous materials originating from timber may be compacted wood pulps. So-called mechanical pulps generally incorporate lignin as well as cellulose whereas chemical pulps generally contain cellulose but little of the original lignin remains. Pulp obtained by a mixture of chemical and mechanical methods may retain some but not all of the original lignin.

Suppliers of such water-swellable disintegrant materials include Rettenmaier in Germany and FMC Corporation in USA. The overall quantity of water-swellable disintegration-promoting material in the tablet is preferably between 0.5 and 15 or 20% by weight, especially between 1 and 8 or 10% by weight, most preferred from 2.5 to 6 wt %.

The water-insoluble, water-swellable disintegrant material which is incorporated into a tablet composition preferably has a mean particle size in a range from 250 μm to 1,500 μm, more preferably from 700 μm to 1,000 μm.

It is also possible to use soluble particles which may for example be selected from salts with a water-solubility exceeding 50 grams per 100 grams water, and mixtures thereof.

As will be explained further below, these disintegration-promoting particles can also contain other forms of tripolyphosphate or other salts within the balance of their composition.

If the material in such water-soluble disintegration-promoting particles can function as a detergency builder, (as is the case with sodium tripolyphosphate) then of course it contributes to the total quantity of detergency builder in the tablet composition.

The total quantity of disintegration-promoting particles may be from 1 or 5% up to 20 or 30 or 40% by weight of the tablet. The quantity may possibly be from 8% up to 25 or 30% or more. However, it is within this invention that the amount of water-soluble disintegration-promoting particles is low, below 5% of the tablet or region, reliance being placed on insoluble water-swellable particles.

One possibility is that these particles contain at least 40% of their own weight, better at least 50%, of a material which has a solubility in deionised water at 20° C. of at least 50 grams per 100 grams of water.

These particles may provide material of such solubility in an amount which is at least 7 wt % or 12 wt % of the composition of the tablet. A solubility of at least 50 grams per 100 grams of water at 20° C. is an exceptionally high solubility: many materials which are classified as water soluble are less soluble than this.

Some highly water-soluble materials which may be used are listed below, with their solubilities expressed as grams of solid to form a saturated solution in 100 grams of water at 20° C.:

| Material | Water Solubility (g/100 g) |
|---|---|
| Sodium citrate dihydrate | 72 |
| Potassium carbonate | 112 |
| Urea | >100 |
| Sodium acetate | 76 |
| Sodium acetate trihydrate | 119 |
| Magnesium sulphate 7H₂O | 71 |

Preferably this highly water soluble material is incorporated as particles of the material in a substantially pure form (i.e. each such particle contains over 95% by weight of the material). However, the said particles may contain material of such solubility in a mixture with other material, provided that material of the specified solubility provides at least 40% by weight of these particles.

A preferred material is sodium acetate in a partially or fully hydrated form.

It may be preferred that the highly water-soluble material is a salt which dissolves in water in an ionised form. As such a salt dissolves it leads to a transient local increase in ionic strength which can assist disintegration of the tablet by preventing nonionic surfactant from swelling and inhibiting dissolution of other materials.

Another possibility is that the said particles which promote disintegration are particles containing sodium tripolyphosphate with more than 40% (by weight of the particles) of the anhydrous phase I form.

Sodium tripolyphosphate is very well known as a sequestering builder in detergent compositions. It exists in a hydrated form and two crystalline anhydrous forms. These are the normal crystalline anhydrous form, known as phase II which is the low temperature form, and phase I which is stable at high temperature. The conversion of phase II to phase I proceeds fairly rapidly on heating above the transition temperature, which is about 420° C., but the reverse reaction is slow. Consequently phase I sodium tripolyphosphate is metastable at ambient temperature.

A process for the manufacture of particles containing a high proportion of the phase I form of sodium tripolyphosphate by spray drying below 420° C. is given in U.S. Pat. No. 4,536,377.

Particles which contain this phase I form will often contain the phase I form of sodium tripolyphosphate as at least 50% or 55% by weight of the tripolyphosphate in the particles.

Suitable material is commercially available. Suppliers include Rhodia.

Another possibility is that the particles which promote disintegration are particles which contain at least 40 wt % (by weight of the particles) of phase I sodium tripolyphosphate which is partially hydrated. The extent of hydration should be at least 0.5% by weight of the sodium tripolyphosphate in the particles. It preferably lies in a range from 0.5 to 4% by weight of the particles, or it may be higher. Indeed fully hydrated sodium tripolyphosphate may be used to provide these particles.

It is possible that the particles contain at least 40 wt % sodium tripolyphosphate which has a high phase I content but is also sufficiently hydrated so as to contain at least 0.5% water by weight of the sodium tripolyphosphate.

The remainder of the tablet composition used to form the tablet or region thereof may include additional sodium tripolyphosphate. This may be in any form, including sodium tripolyphosphate with a high content of the anhydrous phase II form.

Other Ingredients

Tablets of the invention may also contain one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by DSM, Delft, Holland, and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction to form a tablet.

The tablets of the invention may also contain a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material is advantageously included if organic surfactant is present, especially if a detergent tablet is primarily intended for use in front-loading drum-type automatic washing machines. Suitable antifoam materials are usually in granular form, such as those described in EP 266863A (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material. Antifoam granules may be present in an amount up to 5% by weight of the composition.

It may also be desirable that a tablet of the invention includes an amount of an alkali metal silicate, particularly sodium ortho-, meta- or disilicate. The presence of such alkali metal silicates at levels, for example, of 0.1 to 10 wt %, may be advantageous in providing protection against the corrosion of metal parts in washing machines, besides providing some measure of building and giving processing benefits in manufacture of the particulate material which is compacted into tablets. A composition for fabric washing will generally not contain more than 15 wt % silicate. A tablet for machine dishwashing will frequently contain at least 20 wt % silicate.

Further ingredients which can optionally be employed in fabric washing detergent tablets of the invention include anti-redeposition agents such as sodium carboxymethylcellulose, straight-chain polyvinyl pyrrolidone and the cellulose ethers such as methyl cellulose and ethyl hydroxyethyl cellulose, fabric-softening agents; heavy metal sequestrants such as EDTA; perfumes; and colorants or coloured speckles.

Particle Size and Distribution

A tablet of this invention, or a discrete region of such a tablet, is a matrix of compacted particles.

Preferably the particulate composition has an average particle size in the range from 200 to 2000 μm, more preferably from 250 to 1400 μm. Fine particles, smaller than 180 μm or 200 μm may be eliminated by sieving before tableting, if desired, although we have observed that this is not always essential.

While the starting particulate composition may in principle have any bulk density, the present invention may be especially relevant to tablets of detergent composition made by compacting powders of relatively high bulk density, because of their greater tendency to exhibit disintegration and dispersion problems. Such tablets have the advantage that, as compared with a tablet derived from a low bulk density powder, a given dose of composition can be presented as a smaller tablet.

Thus the starting particulate composition may suitably have a bulk density of at least 400 g/liter, preferably at least 500 g/liter, and most preferably at least 600 g/liter.

A composition which is compacted into a tablet or tablet region may contain particles which have been prepared by spray-drying or granulation and which contain a mixture of ingredients. Such particles may contain organic detergent surfactant and some or all of the water-softening agent (detergency builder) which is also present in a detergent tablet.

Granular detergent compositions of high bulk density prepared by granulation and densification in a high-speed mixer/granulator, as described and claimed in EP 340013A (Unilever), EP 352135A (Unilever), and EP 425277A (Unilever), or by the continuous granulation/densification processes described and claimed in EP 367339A (Unilever) and EP 390251A (Unilever), are inherently suitable for use in the present invention.

Preferably, separate particles of the water-insoluble, water-swellable disintegration-promoting material and any water-soluble particles to promote disintegration, are mixed with the remainder of the particulate composition prior to compaction.

Product Forms and Proportions

The present invention may especially be embodied as a tablet for fabric washing. Such a tablet will generally contain, overall, from 5 to 50% by weight of surfactant and from 5 to 80% by weight of detergency builder which is a water softening agent. Water-soluble disintegration promoting particles may be present in an amount from 5% to 35% by weight of the composition. Peroxygen bleach may be present and if so is likely to be in an amount not exceeding 25% by weight of the total composition.

In another type of tablet formulation, the tablet may contain from 0-5% by weight of surfactant, from 0.1-20% by weight of said water-swellable disintegration-promoting particles and either from 50-98% by weight of water-softening agent or from 25 to 85% by weight of a bleach.

The invention may be embodied as tablets whose principal or sole function is that of removing water hardness. In such tablets the water-softening agents, especially water-insoluble aluminosilicate, may provide from 50 to 98% of the tablet composition. A water-soluble supplementary builder may well be included, for instance in an amount from 2% to 30 wt % of the composition, or may be considered unnecessary and not used.

Water-softening tablets embodying this invention may include some surfactant.

The invention may be embodied as tablets for machine dishwashing. Such tablets typically contain a high proportion of water soluble salts, such as 50 to 95% by weight, at least some of which, exemplified by sodium citrate and sodium silicate, have water-softening properties.

Both water-softening and machine dishwashing tablets may include nonionic surfactant which can act as a lubricant during tablet manufacture and as a low foaming detergent during use. The amount may be small, e.g. from 0.2 or 0.5% by weight of the composition up to 3% or 5% by weight.

Tablets for use as a bleaching additive will typically contain a high proportion of peroxygen bleach, such as 25 to 85% by weight of the composition. This may be mixed with other soluble salt as a diluent. The composition of such a tablet may well include a bleach activator such as tetraacetylethylene diamine (TAED). A likely amount would lie in the range from 1 to 20% by weight of the composition.

Tableting

Tableting entails compaction of a particulate composition. A variety of tableting machinery is known, and can be used. Generally it will function by stamping a quantity of the particulate composition which is confined in a die.

The mould in which the tablet is formed may be provided by an aperture within a rigid structure and a pair of particles movable towards each other within the cavity to compact a composition within the aperture. A tableting machine may have a rotary table defining a number of apertures each with a pair or associated dies which can be driven into an apertures. Each die may be provided with an elastomeric layer on its surface which contacts the tablet material, as taught in WO 98/46719 or WO 98/46720.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

If any heat is supplied, it is envisaged that this will be supplied conventionally, such as by passing the particulate composition through an oven, rather than by any application of microwave energy.

The size of a tablet will suitably range from 10 to 160 grams, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids. The overall density of a tablet for fabric washing preferably lies in a range from 1040 or 1050 gm/liter preferably at least 1100 gm/liter up to 1400 gm/liter. The tablet density may well lie in a range up to no more than 1350 or even 1250 gm/liter. The overall density of a tablet of some other cleaning composition, such as a tablet for machine dishwashing or as a bleaching additive, may range up to 1700 gm/liter and will often lie in a range from 1300 to 1550 gm/liter.

The invention will now be further described with reference to the following examples. Further examples within the scope of the present invention will be apparent to the person skilled in the art.

### EXAMPLE I

A detergent base powder, incorporating organic surfactants, a small percentage of crystalline sodium acetate trihydrate, and zeolite MAP detergency builder was made using known granulation technology. It had the following composition, which is shown as parts by weight.

| | Parts by |
|---|---|
| Ingredient Weight | |
| Sodium linear alkylbenzene sulphonate | 20.85 |
| nonionic surfactant (C13-15 branched fatty alcohol 3E0) | 3.07 |
| nonionic surfactant (C13-15 branched fatty alcohol 7E0) | 5.98 |
| Soap | 1.62 |
| zeolite A24 | 46.70 |
| Sodium acetate trihydrate | 5.92 |
| Sodium carbonate | 6.60 |
| sodium carboxymethyl cellulose (SCMC) | 0.64 |
| additional moisture and minor ingredients | 8.50 |
| Total | 100 |

The amount of zeolite MAP (zeolite A24) in the table above is the amount which would be present if it was anhydrous. Its accompanying small content of moisture is included as part of the moisture and minor ingredients.

The base powder and other ingredients were mixed together as set out in the following table, to form compositions indicated as A and B.

Parts by Weight

| | | B |
|---|---|---|
| | A | Comp. |
| Base powder, as above | 55.40 | 57.18 |
| Antifoam (1) | 2.22 | 2.30 |
| Fluorescer (2) | 1.54 | 1.59 |
| Sodium percarbonate | 18.64 | 19.23 |
| TAED (3) | 6.28 | 6.48 |
| Sodium disilicate | 3.95 | 4.07 |
| Soil release polymer (4) | 1.35 | 1.40 |
| Acrylic/maleic copolymer (5) | 1.48 | 1.53 |
| EDTM phosphonate | 0.92 | 0.95 |
| Colored speckles | 1.72 | 1.77 |
| APG paste (6) | 3.00 | — |
| Cellulosic swelling disintegrant (7) | 3.50 | 3.50 |
| Total | 100 | 100 |

Wherein:

(1) Antifoam is 17% silicon oil, 71% sodium carbonate and the remainder petroleum jelly and phosphate ester.

(2) Fluorescer is 9.9% fluorescer and 82.5 sodium carbonate the remainder being minor ingredients

(3) TAED is 83% TAED in 9% sodium sulphate the remainder being minor ingredients.

(4) Soil release polymer is 18% soil-release polymer, 44% zeolite MAP, 21% sodium carbonate and minor ingredients.

(5) Acrylic/maleic polymer is Sokolan CP5 ex BASF (91% active)

(6) APG paste is 50% in water (Glucopon 600CS UP ex Cognis)

(7) Cellulosic swelling disintegrant (Arbocel ex Rettenmaier)

Formulation B (comparison) was made by mixing the ingredients (except for the cellulosic swelling disintegrant) and finally adding the cellulosic swelling disintegrant. Formulation A was made by mixing the ingredients (except for the APG and the cellulosic swelling agent) followed by spraying the APG paste as finely divided droplets onto the mixture and finally adding the cellulosic swelling agent.

Tablets were made in a labscale Grasby Specac tableting press; tablets had a weight of 32.4 grams and a strength (expressed in terms of the diametrical fracture stress) of approximately 25 k Pa. The strength of the tablets, in their dry state as made on the press, was determined as their diametrical fracture stress DFS, which calculated from the equation given earlier:

$$DFS = \frac{2 {F}_{max}}{π Dt}$$

where DFS is the diametrical fracture stress in Pascals, Fₘₐₓ is the applied load in Newtons to cause fracture, D is the tablet diameter in meters and t is the tablet thickness in meters.

The tablets were tested by placing them on a gauze with square openings of 1 cm size each and submerging in a beaker containing 1 liter of tap-water at a temperature of 20° C. The weight of the tablet on the gauze is measured as a function of time until the tablet has completely disintegrated and fallen through the openings in the gauze.

Formulation A required 59.7 seconds before 90% of the tablet disintegrated. This is markedly better than Formulation B (comparison) which required a time of more than 400 seconds before 90% of the tablet disintegrated.

### EXAMPLE II

Tablets of the following formulation were made

| | Parts by |
|---|---|
| Ingredient | weight |
| Zeolite A24 | 44.67 |
| Sodium linear alkylbenzene | 20.74 |
| sulphonate | |
| nonionic surfactant (C13-15 | 3.18 |
| branched fatty alcohol 3E0) | |
| nonionic surfactant (C13-15 | 5.95 |
| branched fatty alcohol 7E0) | |
| Soap | 1.61 |
| Sodium acetate trihydrate | 5.89 |
| Sodium carbonate | 6.57 |
| Sodium carboxy methyl cellulose | 0.63 |
| APG (Glucopon 600CS UP ex Cognis) | 1.25 |
| Additional moisture and minor | To 100 |
| ingredients | |

Base powder formulation IIA was prepared by granulating the components (except the APG-paste) in a high shear granulator. Subsequently the APG paste was sprayed onto these granules.

Base powder formulation IIB (comparison) was prepared by granulating the components (including the APG-paste) in a high shear granulator.

Subsequently these base powder formulations were mixed with further ingredients as detailed in the table below:

Parts by Weight

| | | B |
|---|---|---|
| | A | Comp. |
| Base powder IIA | 57.32 | |
| Base powder IIB | | 57.32 |
| Antifoam (1) | 2.29 | 2.29 |
| Fluorescer (2) | 1.58 | 1.58 |
| Sodium percarbonate | 19.16 | 19.16 |
| TAED (3) | 6.46 | 6.46 |
| Sodium disilicate | 4.06 | 4.06 |
| Soil release polymer (4) | 1.39 | 1.39 |
| Acrylic/maleic copolymer (5) | 1.52 | 1.52 |
| EDTM phosphonate | 0.94 | 0.94 |
| Colored speckles | 1.78 | 1.78 |
| Cellulosic swelling disintegrant (7) | 3.50 | 3.50 |
| Total | 100 | 100 |

Tablets were made in a Grasby Specac labscale tableting press with a weight of 37.5 grams. Tablets had a diametrical fracture stress (DFS) of 31±1.5 kPa.

Disintegration properties were measured in accordance with the procedure given for example I.

Example IIA required 87.8 seconds to reach 75% disintegration of the tablet. Example IIB (Comparison) required 189.6 seconds for 75% disintegration.

1. A tablet of compacted particulate cleaning composition comprising:
(a) a cleaning ingredient selected from the group consisting of organic surfactant, water softening agent, bleach and mixtures thereof, and
(b) from about 0.1 to about 10 wt % of the tablet of a disintegration-promoting material which is an alkyl polyglycoside, and wherein from about 0.1 to about 3 wt % of the tablet is the alkyl polyglycoside present as the coating for from about 30 wt % to about 100 wt % of the particulate cleaning composition.

2. The tablet according to claim 1 wherein the alkyl polyglycoside is selected from alkyl polyglycosides of the formula:
R—O—(C₆H₁₀O₅)ₙ—H (I)
wherein R is a C₄ to C₂₄ alkyl group; and wherein n denotes the average number of sugar groups per molecule and wherein n=from 0.1 to 5.

3. The tablet according to claim 2, wherein R is a C₈ to C₁₆ alkyl group; and wherein n=from 0.5 to 2.0.

4. The tablet according to claim 1 wherein the overall quantity of the alkyl polyglycoside in the tablet is from about 1.0 to about 3.0% by weight of the tablet.

5. The tablet according to claim 1 wherein the quantity of the alkyl polyglycoside present as the coating in the tablet is from about 0.8 to about 2.5 wt % of the tablet.

6. The tablet according to claim 1 wherein the alkyl polyglycoside is present as the coating for about 35 wt % to about 90 wt % of the particulate cleaning composition.

7. The tablet according to claim 1 comprising from about 5 to about 50% by weight of the surfactant and from about 5 to about 80% by weight of the water-softening agent.

8. The tablet according to claim 1 comprising from about 0 to about 5% by weight of the surfactant and from about 50 to about 98% by weight of the water-softening agent.

9. The tablet according to claim 1 comprising from about 0 to about 5% by weight of the surfactant, and from about 25 to about 85% by weight of the bleach.

10. The tablet according to claim 1 wherein the tablet further comprises disintegration-promoting particles containing at least 40% (by weight of the particles) of one or more materials selected from the group consisting of;
compounds with water-solubility exceeding 50 grams per 100 grams water
water swellable materials
phase I sodium tripolyphosphate
sodium tripolyphosphate which is partially hydrated so as to contain water of hydration in an amount which is at least 0.5% by weight of the sodium tripolyphosphate in the particles.

11. The tablet according to claim 10 wherein the water swellable material is selected from the group consisting of cellulose, cross-linked carboxymethyl cellulose, cross-linked polyvinyl pyrrolidone and acrylic/maleic copolymers.

12. The tablet according to claim 1 wherein the water softening agent is a water-insoluble detergency builder, the builder being present in an amount from about 5 to about 98% by weight of the tablet.

13. The tablet according to claim 1 wherein the water softening agent is a water-soluble detergency builder, the builder being present in an amount from about 10 to about 80% by weight of the tablet.

14. Process for making a tablet of compacted particulate cleaning composition, which process comprises the steps of:
a) applying from about 0.1 to about 3 wt % of the tablet of a disintegration-promoting material which is an alkyl polyglycoside as a coating to from about 30 wt % to about 100 wt % of the particulate cleaning composition,
b) placing a quantity of the coated particulate cleaning composition of step a) within a mould, and
c) compacting the composition within the mould to produce the tablet.

15. The process according to claim 14 wherein the alkyl polyglycoside is applied to about 35 wt % to about 90wt % of the particulate cleaning composition.
